(19) United States
(12) Patent Application Publication
(10) Pub. No.: US 2010/0124014 A1
(43) Pub. Date: May 20, 2010

(54) RETAINING DEVICE FOR PERIPHERAL CARD

(75) Inventors: YI-CHENG KUO, Tu-Cheng (TW); LI-CHE LU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/501,500

(22) Filed: Jul. 13, 2009

(30) Foreign Application Priority Data
Nov. 17, 2008 (CN) 200820302820.6

(51) Int. Cl. G06F 1/16

(52) U.S. Cl. 361/679.58

(57) ABSTRACT

A retaining device for securing a peripheral card includes a retaining plate for fastening the peripheral card, a bracket, and a mounting apparatus. The retaining plate includes an elongated base, a blocking tab, and an inserting terminal. The bracket includes a front surface substantially parallel to the elongated base of the retaining plate and a top surface substantially parallel to the blocking tab of the retaining plate. The bracket defines a number of positioning holes at the bottom end thereof for receiving the inserting terminal of the retaining plate. The mounting apparatus is mounted on the top surface of the bracket, and includes a pressing strip for securing the blocking tab of the retaining plate on the top surface of the bracket when the inserting terminal of the retaining plate is inserted into the positioning hole on the front surface of the bracket.

### BACKGROUND

1. Technical Field

The present disclosure relates to retaining devices and, particularly, to a retaining device for peripheral card.

2. Description of Related Art

When new or additional connectors are needed on a computer, a peripheral card having the appropriate connector is installed on the computer motherboard. The peripheral card is inserted in a slot on the motherboard and a bracket on the card is screwed to the computer case for stability of the card. Such a fixing manner not only requires screws but also a screwdriver, this is time-consuming and troublesome, and screws may be misplaced or lost. Moreover, if a screw inadvertently falls on the motherboard and the computer is not properly grounded or when the power is on, damage may occur.

What is needed, therefore, is a retaining device for peripheral card to overcome or at least mitigate the above-described problem.

### BRIEF DESCRIPTION OF THE DRAWINGS

Many aspects of the present retaining device for peripheral card can be better understood with reference to the accompanying drawings. The components in the drawings are not necessarily drawn to scale, the emphasis instead being placed upon clearly illustrating the principles of the present retaining device for peripheral card. In the drawings, all the views are schematic.

FIG. 1 is a schematic view of a retaining device for peripheral card according to an exemplary embodiment.

FIG. 2 is an exploded view of the retaining device of FIG. 1.

FIG. 3 is a schematic view of a bracket of the retaining device of FIG. 1 viewed from another side.

### DETAILED DESCRIPTION

Embodiments of the present disclosure will now be described in detail below, with reference to the accompanying drawings.

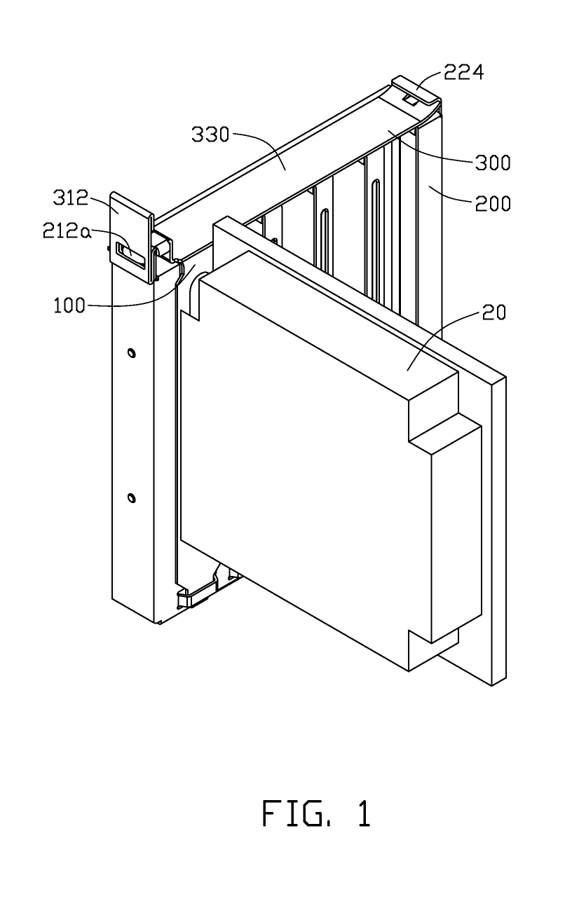

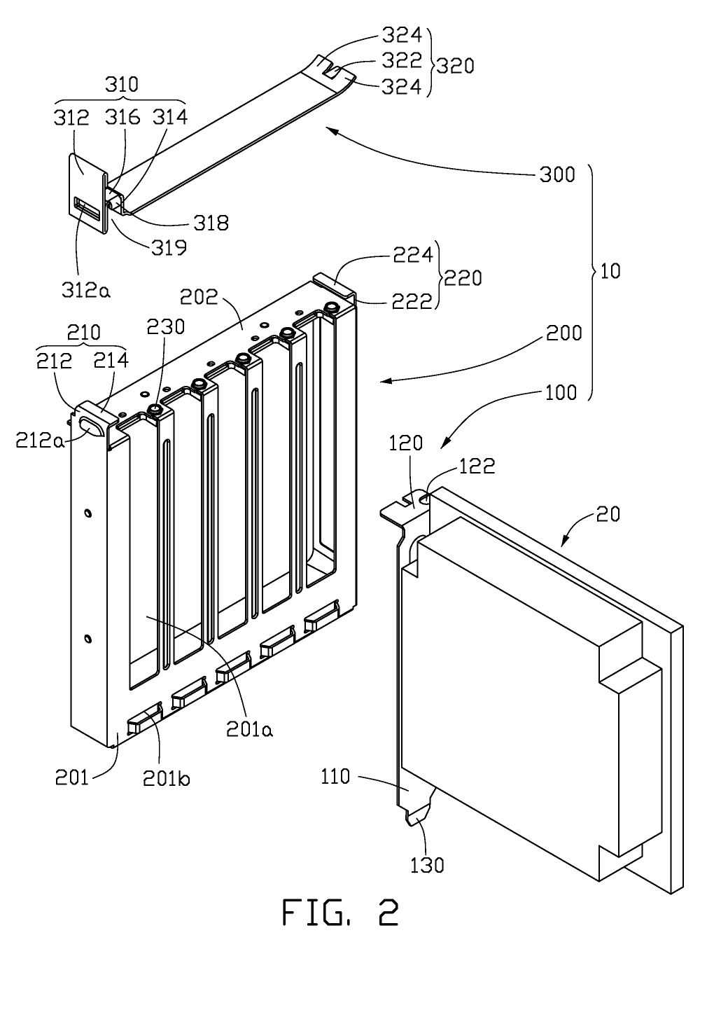

Referring to the FIG. 1 and FIG. 2, a retaining device 10 for securing a peripheral card 20 to a computer housing (not shown), according to an exemplary embodiment, is shown. The retaining device 10 includes a retaining plate 100 for fastening the peripheral card 20, a bracket 200 secured to or a part of a computer housing, and a mounting apparatus 300. The peripheral card 20 is rectangular with a connecting portion (not shown) protruding from one side thereof.

The retaining plate 100 is substantially L-shaped, including an elongated base 110, a blocking tab 120 perpendicularly extending from an end of the elongated base 110, and an inserting terminal 130 extending from the other end of the elongated base 110. The blocking tab 120 defines a cutout 122 with an opening facing towards a direction perpendicular to the peripheral card 20.

The bracket 200 includes a front surface 201 facing the retaining plate 100, and a top surface 202 connecting with the front surface 201. The front surface 201 is substantially parallel to the elongated base 110 of the retaining plate 100, and the top surface 202 is substantially parallel to the blocking tab 120 of the retaining plate 100. The front surface 201 defines a number of slots 201a extending along a direction perpendicular to the top surface 202 for receiving the elongated base 110 of the retaining plate 100. The front surface 201 also defines a number of positioning holes 201b at the bottom end thereof away from the top surface 202 corresponding to the slots 201a. Each positioning hole 201b is located on the extending direction of the corresponding slot 201a. The positioning hole 201b is used for receiving the inserting terminal 130 of the retaining plate 100. The bracket 200 also includes a number of positioning posts 230 located on the top surface 202 corresponding to the slots 201a. The positioning post 230 is used for latching with the cutout 122 of the retaining plate 100.

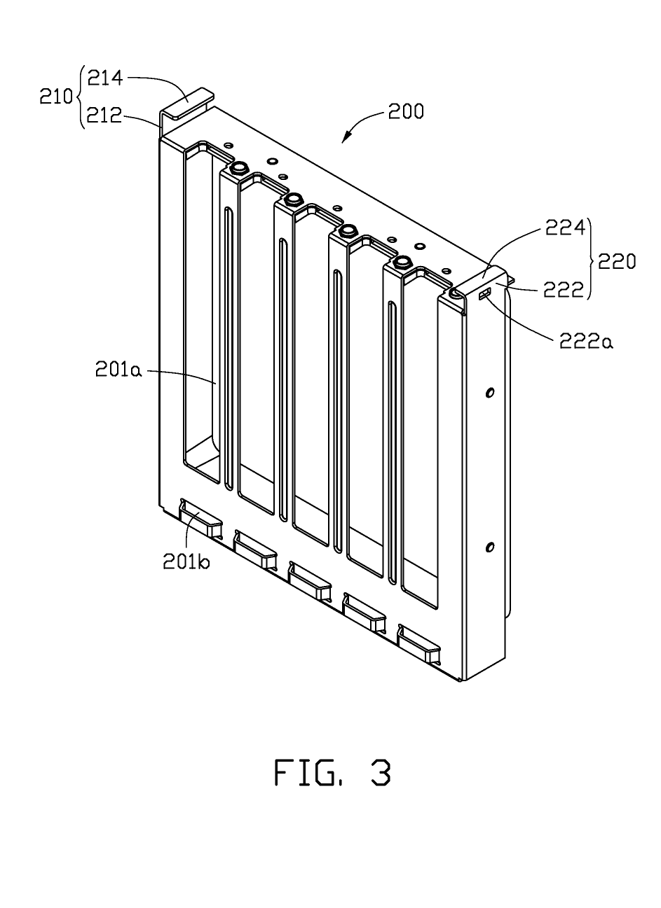

The bracket 200 includes a first latching member 210 and a second latching member 220 located at two opposite ends of the top surface 202, respectively. The first latching member 210 is substantially L-shaped, including a first upright plate 212 and a first horizontal plate 214 extending from an end of the first upright plate 212 away from the top surface 202 of the bracket 200. The first upright plate 212 is substantially perpendicular to the top surface 202 of the bracket 200, and the first horizontal plate 214 is substantially parallel to the top surface 202 of the bracket 200. A latching protrusion 212a extends from a surface of the first upright plate 212 facing away from the second latching member 220. The second latching member 220 is substantially L-shaped, including a second upright plate 222 and a second horizontal plate 224 extending from an end of the second upright plate 222 away from the top surface 202 of the bracket 200. The second upright plate 222 is substantially perpendicular to the top surface 202 of the bracket 200, and the second horizontal plate 224 is substantially parallel to the top surface 202 of the bracket 200. Further referring to FIG. 3, the second upright plate 222 defines a through hole 222a.

The mounting apparatus 300 includes a resilient pressing strip 330, a first latching portion 310, and a second latching portion 320. The pressing strip 330 can be flat or curved towards the top surface 202 of the bracket 200. The first latching portion 310 and the second latching portion 320 extend from two ends of the pressing strip 330 respectively.

The first latching portion 310 latches with the first latching member 210 of the bracket 200. The first latching portion 310 includes a third upright plate 314, a third horizontal plate 316, and a fourth upright plate 312 extending from an end of the pressing strip 330 in sequence. The third upright plate 314, the third horizontal plate 316, and the fourth upright plate 312 cooperatively define a recess 319 for receiving the first latching member 210. The fourth upright plate 312 defines a latching hole 312a for latching with the latching protrusion 212a of the first latching member 210. Two blocking plates 318 extend towards the top surface 202 from two opposite ends of the third horizontal plate 316 for preventing the first latching member 210 from moving along a direction perpendicular to the front surface 201 of the bracket 200.

The second latching portion 320 latches with the second latching member 220 of the bracket 200. The second latching portion 320 includes an inserting plate 322 and two bending plates 324. The inserting plate 322 is inserted into the through hole 222a of the second upright plate 222 of the second latching member 220. The two bending plates 324 bend towards a direction away from the top surface 202 of the bracket 200, and abut the second horizontal plate 224 of the second latching member 220.

In assembly, the retaining plate 100 with the peripheral card 20 secured thereon is placed on the front surface 201 of the bracket 200. The inserting terminal 130 of the retaining plate 100 is inserted into the corresponding positioning slot 201b defined on the front surface 201 of the bracket 200, and the blocking tab 120 is attached to the top surface 202 of the bracket 200 with the cutout 122 of the blocking tab 120 latching with the positioning post 230 of the bracket 200. Then the mounting apparatus 300 will be mounted on the top surface 202 of the bracket 200. The first latching portion 310 and the second latching portion 320 latch with the first latching member 210 and the second latching member 220 respectively. Therefore, the resilient pressing strip 330 can prevent the retaining plate 100 from being pulled out. Accordingly, the peripheral card 20 can be secured properly.

While certain embodiments have been described and exemplified above, various other embodiments will be apparent to those skilled in the art from the foregoing disclosure. The invention is not limited to the particular embodiments described and exemplified, and the embodiments are capable of considerable variation and modification without departure from the scope and spirit of the appended claims.

What is claimed is:

1. A retaining device for securing a peripheral card to a computer housing comprising:
a retaining plate for fastening the peripheral card, the retaining plate comprising an elongated base, a blocking tab perpendicularly extending from an end of the elongated base, and an inserting terminal extending from the other end of the elongated base;
a bracket comprising a front surface substantially parallel to the elongated base of the retaining plate and a top surface substantially parallel to the blocking tab of the retaining plate, the bracket defining a plurality of positioning holes at the bottom end of the front surface away from the top surface for receiving the inserting terminal of the retaining plate; and
a mounting apparatus mounted on the top surface of the bracket, the mounting apparatus comprising a pressing strip for securing the blocking tab of the retaining plate on the top surface of the bracket when the inserting terminal of the retaining plate is inserted into one of the plurality of positioning holes on the front surface of the bracket.

2. The retaining device of claim 1, wherein the blocking tab of the retaining plate defines a cutout, and the bracket comprises a plurality of positioning posts for latching with the cutout of the retaining plate.

3. The retaining device of claim 1, wherein the front surface of the bracket further defines a plurality of slots corresponding to the plurality of positioning holes, and the plurality of slots extend along a direction perpendicular to the top surface for receiving the elongated base of the retaining plate.

4. The retaining device of claim 3, wherein each positioning hole is located on the extending direction of the corresponding slot.

5. The retaining device of claim 1, wherein the bracket comprises a first latching member and a second latching member located at two opposite ends of the top surface, and the mounting apparatus further comprises a first latching portion and a second latching portion extending from two ends of the pressing strip respectively for latching with the first latching member and the second latching member, respectively.

6. The retaining device of claim 5, wherein the first latching member comprises a first upright plate substantially perpendicular to the top surface and a latching protrusion extending from a surface of the first upright plate facing away from the second latching member, and the first latching portion of the mounting apparatus comprises a fourth upright plate defining a latching hole thereon for latching with the latching protrusion of the first latching member.

7. The retaining device of claim 6, wherein the first latching portion of the mounting apparatus further comprises a third upright plate and a third horizontal plate; the third upright plate, the third horizontal plate, and the fourth upright plate extend from an end of the pressing strip in sequence; and the third upright plate, the third horizontal plate, and the fourth upright plate cooperatively define a recess for receiving the first latching member.

8. The retaining device of claim 7, wherein the first latching member further comprises a first horizontal plate extending from an end of the first upright plate away from the top surface, and the first latching portion further comprises two blocking plates extending towards the top surface from two opposite ends of the third horizontal plate for preventing the first latching member from moving along a direction perpendicular to the front surface of the bracket.

9. The retaining device of claim 5, wherein the second latching member comprises a second upright plate substantially perpendicular to the top surface, the second upright plate defines a through hole thereon, and the second latching portion comprises an inserting plate capable of being inserted into the through hole.

10. The retaining device of claim 9, wherein the second latching member further comprises a second horizontal plate extending from an end of the second upright plate away from the top surface, and the second latching portion further comprises at least one bending plate bending towards a direction away from the top surface, and abutting the second horizontal plate.

11. The retaining device of claim 1, wherein the pressing strip is resilient.

12. The retaining device of claim 1, wherein the pressing strip is flat.

13. The retaining device of claim 1, wherein the pressing strip is curved towards the top surface of the bracket.

14. The retaining device of claim 1, wherein the bracket is a part of the computer housing.

15. The retaining device of claim 1, wherein the bracket is secured to the computer housing.
